(19) United States
(12) Patent Application Publication
(10) Pub. No.: US 2026/0195695 A1
(43) Pub. Date: Jul. 9, 2026

(54) Techniques for Self-Guided Hyper Personalization Governance Using Nested Machine Learning Models

(71) Applicant: TEACHERS INSURANCE AND ANNUITY ASSOCIATION OF AMERICA, New York, NY (US)

(72) Inventors: Sastry Vsm Durvasula, Phoenix, AZ (US); Swatee Singh, Livingston, NJ (US); Rares Ioan Almasan, Paradise Valley, AZ (US); Sonam Jha, Skillman, NJ (US); Rajiv Dulepet, West Hills, CA (US)

(21) Appl. No.: 19/008,909

(22) Filed: Jan. 3, 2025

(51) Int. Cl. G06Q 10/067; G06N 5/02; G06Q 10/105

(52) U.S. Cl. CPC G06Q 10/067; G06N 5/02; G06Q 10/105

(57) ABSTRACT

Systems and methods are described for managing governance operating parameters through the use of machine learning. The method involves: (i) receiving knowledge data, wherein the knowledge data is indicative of one or more operating parameters; (ii) analyzing, using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data; (iii) determining, based on the analyzing, a compliance action, wherein the compliance action is associated with configuring the subset of the one or more operating parameters associated with the input; and (iv) generating, by the one or more processors using the nested machine learning model, a recommendation associated with the compliance action.

### FIELD OF THE INVENTION

The present aspects relate to techniques for managing governance operating parameters using machine learning, and more particularly, to techniques using a nested machine learning model to configure and/or generate recommendations regarding compliance actions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In recent years, generative artificial intelligence technologies have seen widespread adoption across various industries, driven by the ability of such technologies to generate new content, predict outcomes, and automate complex processes. However, the rapid integration of generative AI has raised significant challenges related to standardization, compliance, and the management of AI-generated outputs. Organizations struggle to align the capabilities of generative AI with internal policies, regulations, and ethical standards, often resulting in inconsistent applications and potential risks in decision-making processes. Moreover, the dynamic nature of regulatory environments and organizational policies necessitates flexible systems capable of adapting to new standards and requirements.

Furthermore, the utilization of generative AI in processing sensitive information, such as personally identifiable information (PII), introduces additional complexities. Ensuring content moderation, data privacy, and compliance with stringent regulatory frameworks while leveraging the potential of generative AI remains a formidable task. Traditional systems often lack the sophistication to dynamically adjust to varied and evolving data privacy laws across jurisdictions and/or user preferences. Such limitations hamper the ability of organizations to fully exploit the benefits of generative AI technologies in a manner that is both efficient and compliant with existing legal and ethical standards.

Moreover, the integration of generative AI into organizational frameworks requires a nuanced understanding of the technology's potential biases and limitations. The development of mechanisms for improvement of bias detection, synthetic testing data generation, and model accuracy and compliance are critical. Existing solutions may not adequately address the aforementioned needs, particularly in complex operational environments that require the processing of unstructured data from diverse sources. As such, there are significant opportunities for improved platforms and technologies for solving the identified conventional problems.

### BRIEF SUMMARY OF THE INVENTION

In one aspect, a computer-implemented method for managing governance operating parameters using machine learning includes: (1) receiving, by one or more processors, knowledge data, wherein the knowledge data is indicative of one or more operating parameters; (2) analyzing, by the one or more processors using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data; (3) determining, by the one or more processors based on the analyzing, a compliance action, wherein the compliance action is associated with configuring the subset of the one or more operating parameters associated with the input; and (4) generating, by the one or more processors using the nested machine learning model, a recommendation associated with the compliance action.

In another aspect, a computing system for managing governance using machine learning includes: (1) one or more processors; and (2) one or more non-transitory memories, the one or more non-transitory memories includes computer-executable instructions that, when executed by the one or more processors, cause the one or more processors to: (a) receive knowledge data, wherein the knowledge data is indicative of one or more operating parameters; (b) analyze, using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data; (c) determine based on the analyzing, a compliance action, wherein the compliance action is associated with configuring the subset of the one or more operating parameters associated with the input; and (d) generate using the nested machine learning model, a recommendation associated with the compliance action.

In yet another aspect, a computer-readable medium includes instructions that, when executed on a processor, cause the processor to perform operations for managing governance using machine learning, the operations comprising: (1) receiving knowledge data wherein the knowledge data is indicative of one or more operating parameters; (2) analyzing, using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data; (3) determining, based on the analyzing, a compliance action, wherein the compliance action is associated with configuring the subset of the one or more operating parameters associated with the input; and (4) generating, using the nested machine learning model, a recommendation associated with the compliance action.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 illustrates an advanced computing environment designed for governance management using machine learning, focusing on standardizing and implementing AI-configured guardrails for user inputs within organizations.

FIG. 2 illustrates a comprehensive system architecture for managing and governing data input and process flows within a computing environment.

FIG. 3 illustrates a data processing machine learning model for transforming use case knowledge data into codified knowledge data.

FIG. 4 illustrates a data processing machine learning model generally similar to the data processing machine learning model of FIG. 3, except the data processing machine learning model transforms use case scoping knowledge data.

FIG. 5 illustrates a data processing machine learning model generally similar to the data processing machine learning model of FIG. 3, except the data processing machine learning model transforms cyber knowledge data.

FIG. 6 illustrates a data processing machine learning model generally similar to the data processing machine learning model of FIG. 3, except the data processing machine learning model transforms legal, regulatory, and compliance knowledge data.

FIG. 7 illustrates a data processing machine learning model generally similar to the data processing machine learning model of FIG. 3, except the data processing machine learning model transforms persona knowledge data.

FIG. 8 illustrates a data processing machine learning model generally similar to the data processing machine learning model of FIG. 3, except the data processing machine learning model transforms solution knowledge data.

FIG. 9 illustrates a data processing machine learning model generally similar to the data processing machine learning model of FIG. 3, except the data processing machine learning model external documents analyzer knowledge data.

FIG. 10 illustrates a data processing machine learning model generally similar to the data processing machine learning model of FIG. 3, except the data processing machine learning model transforms synthetic knowledge data.

FIG. 11 illustrates a system for self-guided hyper-personalization governance that encompasses various modules and agents responsible for specific functions within the system, ensuring content contextualization, personalization, and compliance.

FIG. 12 illustrates a flow diagram for self-guided hyper-personalization governance that details the process from receiving user input to generating a recommendation associated with a compliance action, tailored to meet personalized access and requirements.

### DETAILED DESCRIPTION

The present techniques introduce a comprehensive approach to managing governance operating parameters within organizations through the use of machine learning. The system implements a nested machine learning model, which is designed to process and analyze knowledge data indicative of various operating parameters. The nested machine learning model includes a master governance agent comprising an array of agent models. The agent models, including but not limited to a first agent, a second agent, and one or more third agents, are trained using composite knowledge data. The data processing machine learning models may generate the codified knowledge data prior to training based on the initial knowledge data received.

The system may further utilize a persona identification module that analyzes user interactions, historical data, and/or contextual information to categorize users into distinct personas. Each persona is associated with a unique set of operating parameters and compliance requirements, reflecting the specific needs and roles within the organization. Based on the user categorization, the system dynamically adjusts guardrails and tailors compliance actions to align with the persona-specific requirements. The personalized approach to persona identification ensures that governance actions are relevant and effectively maintain privacy and security requirements, improving compliance while accommodating the diverse operational contexts within the organization.

The agents may collaborate to process inputs from a variety of sources, including use case intake forms, use case scoping documents, solution design documents, technical documents, and/or external documents detailing regulations and industry standards. By incorporating advanced techniques such as bias detection and synthetic data generation, the framework aims to test different scenarios. Such techniques improve the model's accuracy by (i) reducing bias in data and algorithms which would otherwise skew results and lead to inaccurate outcomes, while (ii) ensuring compliance with relevant standards.

The system incorporates advanced bias detection algorithms that actively monitor and analyze the output of the machine learning models for any signs of bias. The bias detection algorithms are designed to identify biases based on predefined criteria, including, but not limited to, demographic disparities, outcome inconsistencies, and data source biases. Once identified, the biases are categorized and mitigated through a combination of model retraining, data augmentation, and algorithmic adjustments to ensure fairness and accuracy in the system's outputs. Additionally, the system employs synthetic data generation techniques to create diverse and comprehensive datasets that simulate a wide range of scenarios for system validation. The synthetic data is used to test the system's performance and compliance under various conditions, thereby enhancing the reliability of the governance framework.

The system further incorporates anomaly detection in AI and machine learning as a technique used to identify patterns in data that do not conform to expected behavior. Anomaly detection is important across various applications, including fraud detection, network security, and monitoring system health. Anomaly detection algorithms analyze data to find outliers or unusual occurrences, which can indicate potential issues or malicious activity. Anomaly detection algorithms can be supervised, semi-supervised, or unsupervised, depending on the availability of labeled data. Effective anomaly detection helps organizations to quickly identify and respond to potential threats, ensuring the integrity and reliability of their systems.

Further, the instant techniques may include a feedback management module that captures user responses and system performance metrics to utilize the system's capability for real-time feedback and model auto-tuning. The feedback management module analyzes feedback to identify trends, anomalies, and areas for improvement. Based on the analysis, the system may automatically adjust policies, guardrails, and model parameters in real-time, leveraging machine learning algorithms to optimize governance strategies continuously. Such an adaptation process ensures that the system remains responsive to changing conditions and user needs.

Instant techniques may also include federated learning. Federated learning is a machine learning approach that enables models to be trained across multiple decentralized devices or servers holding local data samples, without exchanging them. Federated learning is particularly useful for preserving privacy and complying with data regulations, as federated learning allows for the collective improvement of models without the need to share sensitive or proprietary information. Federated learning involves training local models on individual datasets, then aggregating the updates (e.g., model weights) to improve a global model. The federated learning process is repeated iteratively, leading to enhanced model performance without direct access to the underlying data. Federated learning may particularly improve data privacy and/or collection or handling of personally identifiable information (PII), as models are trained across devices without actually exchanging PII or other private data.

One of the key benefits of the framework is the emphasis on transparency and clear explanations in AI decision-making. By ensuring that the actions taken by the agents utilize synthesized historical, and real-time feedback data, and are relevant to the specific use case or persona, the framework improves efficiency in decision-making for managing governance. Additionally, the framework is designed to balance growth, efficiency, and risk protection in a scalable and continuously evolving manner. By leveraging such advancements in generative AI while adhering to organizational and regulatory standards, organizations can utilize generative AI to improve overall operations while maintaining security and privacy standards inherent in various roles.

“Personally identifiable information” (PII) may be used herein to refer to any data that can be used to identify a specific individual. Examples of PII may include names, addresses, phone numbers, social security numbers, email addresses, medical information, financial information, and/or any other such private information. In the context of AI and machine learning, handling PII requires stringent measures to ensure privacy and compliance with data protection regulations such as the General Data Protection Regulation (GDPR) of the EU and California Consumer Privacy Act (CCPA) of California. Techniques to safeguard PII as used herein may include data anonymization, encryption, and the implementation of strict access controls. The instant techniques may improve overall management of PII through implementation of such techniques and accurate determination of proper rules and/or guidelines so as to prevent unauthorized access or disclosure of sensitive information.

The handling of PII varies with different personas and based on corresponding roles and responsibilities for the personas. For instance, an HR persona, due to a corresponding involvement in employee management, may require access to a broad spectrum of PII, requiring stringent guardrails such as enhanced data encryption and strict access controls to safeguard sensitive information. Conversely, a marketing persona primarily dealing with aggregated data for analysis and campaign planning may have limited access to PII. For the marketing persona, guardrails may focus on ensuring that any PII accessed is anonymized or pseudonymized to prevent identification of individuals. Learning team personas interacting with a mix of publicly available and proprietary educational content may encounter PII in specific contexts, such as user feedback or performance tracking. Guardrails for the learning team persona may dynamically adjust based on the sensitivity of the PII encountered, such as masking user feedback or requiring more stringent authentication for performance tracking. Business personas for executives or project managers may require access to PII across various levels of sensitivity depending on the project or departmental needs. For business personas, guardrails may include customizable privacy settings and periodic security audits to comply with organizational policies and regulatory standards. The instant techniques may provide a tailored approach to PII access for each persona, and may therefore determine how and when to adjust the associated guardrails to maintain compliance with applied standards.

As mentioned above, an HR persona typically requires access to sensitive personal data, including PII of employees. To determine appropriate operation rules and/or guidelines for such a persona, the system may analyze the knowledge data to identify operating parameters requiring stringent data protection measures. For instance, the compliance action may involve configuring user access credentials to include multi-factor authentication and data encryption, ensuring that HR personnel can access the necessary information while maintaining the confidentiality and integrity of employee data.

A marketing persona may need access to aggregated customer data for campaign analysis and targeting. While the aggregated customer data may be less sensitive than PII, the aggregated customer data may still benefit from a degree of privacy protection. As such, the system may determine a compliance action that configures access controls to limit data visibility to pseudonymized datasets, preventing unauthorized access to individual customer details. Additionally, the recommendation for a compliance action may include guidelines for secure data handling practices tailored to marketing operations, or suggestion of software solutions that automatically process PII to remove or obscure identifying details before the identifying details are accessed by marketing personnel.

Learning teams often require access to a wide range of resources, from publicly available educational materials to proprietary training content. As mentioned above, the security and privacy levels for this persona can vary significantly based on the type of content accessed. The system may therefore generate aligned knowledge data that dynamically adjusts security measures based on the sensitivity of the content being accessed. For example, accessing proprietary training modules may trigger compliance actions that enforce stricter access controls and content encryption, whereas publicly available materials may have fewer restrictions.

As mentioned above, business personas may have needs that span across various levels of security and privacy, depending on the project or department with which the persona(s) are involved with. The system may utilize the persona matching module to tailor compliance actions and recommendations to the specific context of activities for each business persona. Such recommendations may include recommendations for a compliance action associated with customizable privacy settings for project data, secure communication channels for sensitive discussions, and/or periodic security audits.

The process may begin with data processing machine learning model(s) receiving knowledge data. The knowledge data may function as an initial starting point for subsequent analysis and decision-making processes. The nested machine learning model 134 then analyzes inputs associated with a subset of the operating parameters. The analysis may be based on the composite knowledge data, which encapsulates a broader spectrum of information than the initial knowledge data. Based on the input analysis, the model determines a compliance action, which is associated with configuring the subset of operating parameters in question. The process concludes with the generation of a recommendation associated with the determined compliance action, thereby providing actionable insights for governance management.

One of the improvements introduced by the present techniques is the enhancement of processing capabilities. By leveraging a nested machine learning model 134, the techniques enable more efficient and accurate analysis of knowledge data, thereby streamlining the decision-making process. The enhancement of processing capabilities not only improves speed, but also the quality of decisions made by the model, ensuring that compliance actions are enforced properly, maintaining the overall efficiency while improving general security and privacy by enforcing the associated requirements.

Another notable improvement from the techniques disclosed is the improvement of network usage. The present techniques facilitate a more effective utilization of network resources by improving the flow of data between the various components of the system. The improvement to network usage is achieved through the deployment of agent models, each designed to handle specific aspects of the governance management process. By reducing unnecessary data transmissions and focusing on relevant information, the techniques contribute to more efficient network usage, thereby reducing bottlenecks and enhancing overall system performance.

Memory usage is also enhanced with the implementation of the present techniques. By employing machine learning models that are trained on composite knowledge data, the system can make more informed decisions without the need to store vast amounts of raw data. The enhanced memory usage not only conserves memory resources but also ensures that the data retained is of the highest relevance and utility for governance management purposes.

In summary, the present techniques introduce an effective method for managing an organization's governance by way of personas using machine learning. Through the deployment of a nested machine learning model comprising various agent models, the techniques offer significant improvements in processing capabilities, network usage, and memory usage. These enhancements collectively contribute to a more efficient, accurate, and scalable approach to governance management, adaptable across different organizational contexts and industries.

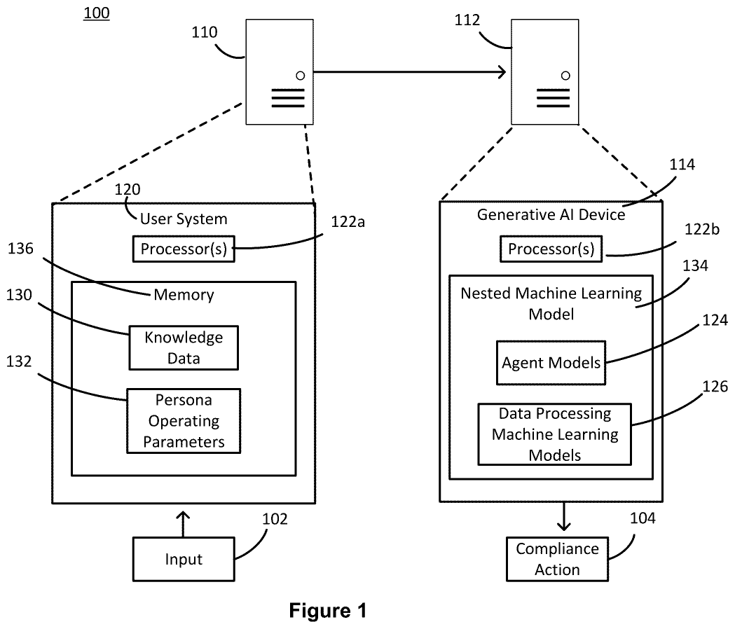

Referring now to the drawings, FIG. 1 depicts an exemplary computing environment 100 for managing governance and using machine learning to implement AI-configured guardrails for user inputs 102 within organizations, according to some embodiments. The computing environment 100 ensures compliance with organizational standards, policies, and regulations while leveraging generative AI across various industries. The computing environment 100 includes a user system 120 and a generative AI device 114. The computing environment 100 is adaptable and applicable to any organization, not limited to a specific industry or domain. The high-level architecture illustrated in FIG. 1 may include both hardware and software applications, as well as various data communications channels for communicating data between the various hardware and software components, as is described below. The architecture illustrated in FIG. 1 further includes various components and channels for communication and data flow, as is described below.

Although one user system 120 and one generative AI device 114 are shown in FIG. 1, any number of such user systems 120 and generative AI devices 114 may be included in various embodiments. The computing environment 100 may include one or more user systems 120, and generative AI devices 114 configured to communicate with one another. The user system 120 and the generative AI device 114 may comprise processors 122a and 122b, wherein both systems have computing capabilities.

The user system 120 contains one or more memories 136, which may further include knowledge data 130 and persona operating parameters 132. In some embodiments, the user system 120 includes storage capabilities for various data types that are utilized in or during operation. The memories 136 of the user systems 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memories 136 of the user systems 120 may also store a web browser via which a user can access a service provided by the organization that owns the user system 120 or via which a user can operate or access a user application that accesses the user systems 120.

Additionally, the user system 120 receives input data for processing from a user input 102. Further, the generative AI device 114, using the processor(s) 122b and nested machine learning model 134, generates a compliance action 104. The compliance action 104 is an output related to configuring user access credentials to a user system 120 based on the one or more persona operating parameters 132.

The generative AI device 114 includes processor(s) 122b and a nested machine learning model 134 comprised of one or more agent models 124, and one or more data processing machine learning models 126. The generative AI device 114 uses machine learning capabilities within the agent models 124 and data processing machine learning models 126 to synthesize data and train agent models 124 on analyzing user input 102.

The user systems 120 and generative AI device(s) 114 may comprise one or more servers 110, 112, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) (e.g., CPUs) as well as one or more computer memories 136. While the user systems 120 user systems 120 and generative AI device(s) 114 are shown operating on two separate systems, the user systems 120 user systems 120 and generative AI device(s) 114 can operate on a single server 110, or on more than one server 110, 112. Either or both user system 120 and generative AI device(s) 114 can further include a user interface to display alerts or other indications as described later herein. The user interfaces may be provided in whole or in part on a display monitor (e.g., LCD screen, touch screen, or any other type of display), and can incorporate an integrated or separate sound system.

In some embodiments, the nested machine learning model 134 may be executed on the generative AI device 114, while in other examples the generative AI device 114 may provide, transmit, or send training data (e.g., training data described above including security risk scores of a plurality of interfaces, outputs of execution instances of the plurality of interfaces, and characteristics of the plurality of interfaces) to another computing system and the other computing system can execute the nested machine learning model 134 based on the training data and provide results back to the generative AI device 114. Moreover, in some examples, the nested machine learning model 134 may be trained by a machine learning model training application executing on the generative AI device 114, while in other examples, the nested machine learning model 134 may be trained by a machine learning model training application executing on another computing system, separate from the generative AI device 114.

Whether the nested machine learning model 134 is trained on the generative AI device 114 or elsewhere, the nested machine learning model 134 may be trained by the machine learning model training application using the knowledge data. The generative AI device 114 can automatically generate a configuration for a user system 120 credential configuration of a user system 120. For example, if a user has requested access that does not match their persona, the generative AI device 114 can generate a compliance action 104 relating to appropriate user access to a user system 120. For instance, if the user matches a business persona, but requests access to the system that appropriate for an HR persona, the generative AI device 114 will recommend a compliance action 104 associated with configuring user access to PII and the user system 120 that aligns with the business persona.

Machine learning model(s) may be created and trained based upon example data (e.g., “training data”) inputs or data (which may be termed “features” and “labels”) to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

The disclosed system provides a method for training machine learning models, including large language models (LLMs), by processing datasets to improve model parameters for specific tasks. LLMs are AI systems trained on extensive corpora of text data to understand and generate human-like text. These models, such as GPT (Generative Pre-trained Transformer) and other such models, leverage deep learning techniques to process and produce text that can mimic human writing styles, answer questions, summarize information, and more. The training process involves the use of extensive preprocessed datasets that may include textual, numerical, or multimodal data. The system may employ techniques such as gradient descent to adjust model weights iteratively. For example, during training, data is divided into batches, and each batch is passed through the model to compute predictions. The loss between predictions and ground truth labels is calculated using a loss function, and gradients are backpropagated through the model to update the model's parameters. The training process is repeated over multiple epochs until convergence criteria are met.

In some embodiments, the system may additionally include mechanisms for fine-tuning pre-trained LLMs on domain-specific datasets to improve task performance. Fine-tuning involves initializing the model with weights from a pre-trained state and then training the model further on a smaller, curated dataset specific to the desired application. Regularization techniques such as dropout and weight decay are employed during fine-tuning to prevent overfitting and maintain generalization. Additionally, optimization algorithms such as Adam or RMSProp may be used to adapt the learning rate dynamically, ensuring stability and convergence throughout training.

In some embodiments, to enhance training efficiency the system implements distributed training across multiple computational nodes. Each node processes a subset of the data in parallel, and updates to model parameters are synchronized across nodes using methods such as gradient averaging or parameter server architectures. The distributed training approach enables the system to handle large datasets and high-dimensional models efficiently. The system also incorporates mixed-precision training, where lower-precision arithmetic is used for certain computations to reduce memory usage and improve computational speed without compromising model accuracy.

In some embodiments, the training process for LLMs may include the use of specialized tokenization methods to preprocess textual input. Tokenization involves converting raw text into tokens that represent words, subwords, or characters, depending on the model architecture. The tokens are mapped to unique identifiers and fed into the model's embedding layer. Positional encodings are added to the embeddings to capture the order of tokens within the input sequence. Attention mechanisms, such as those used in transformer architectures, process these embeddings to capture long-range dependencies in the text, ensuring the model learns contextually relevant patterns.

In some embodiments, the disclosed system employs a validation phase during training to evaluate model performance on unseen data. At regular intervals, a separate validation dataset is used to compute metrics such as accuracy, loss, or F1 score. These metrics guide the adjustment of hyperparameters such as learning rate, batch size, and dropout rate. Early stopping mechanisms halt training when validation performance plateaus or deteriorates, preventing overfitting. The system also includes functionality for saving checkpoints of model parameters at regular intervals, allowing training to resume from the latest checkpoint in case of interruption.

These training methods may be applied to develop machine learning models, particularly LLMs, that can perform tasks such as natural language understanding, text generation, and context-aware reasoning. By leveraging large-scale data, efficient training algorithms, and advanced architectures, the disclosed system improves LLM performance for a wide range of applications.

In some embodiments, the nested machine learning model 134 generates vector embeddings to represent entities, concepts, or objects in a high-dimensional numerical space. Such embeddings may be created by processing input data using techniques such as word2vec, GloVe, or transformer-based models. The input data may include textual descriptions, contextual relationships, or domain-specific metadata. Each entity is mapped to a unique embedding, encapsulating the entity's features and relationships within the dataset. The embeddings are stored in a structured vector space that allows for efficient similarity computations using methods such as cosine similarity or Euclidean distance.

In some embodiments, the generated vector embeddings may be stored in a database that supports scalable retrieval and computation. The system may enable queries to identify embeddings that are similar based on a spatial proximity in the vector space. Proximity measurements are used to infer relationships, clusters, or patterns among entities. The embeddings may be updated periodically through a feedback mechanism that incorporates data from user interactions and performance metrics. The embeddings update process ensures the embeddings remain aligned with evolving datasets and tasks. The system also provides tools to query and analyze the embedding space for trends or outliers.

In some embodiments, the nested machine learning model 134 integrates knowledge graphs to represent structured relationships between entities. Each knowledge graph consists of nodes, which correspond to entities, and edges, which define relationships between these nodes. The graph structure captures both explicit relationships and inferred associations. Node attributes and edge properties provide additional contextual information about entities and corresponding connections. The nested machine learning model 134 supports the dynamic creation, update, and management of the knowledge graph as new data is ingested or relationships are modified.

In some embodiments, the nested machine learning model 134 integrates vector embeddings with the knowledge graph to enhance the utility for queries and reasoning. Each node in the graph is associated with a corresponding vector embedding, which is generated or updated based on the attributes of the node and the graph structure. Embedding generation methods include graph convolutional networks or graph attention networks, which incorporate both local and global structural properties of the graph. The system also allows embeddings to be generated for unstructured data, enabling incorporation into the knowledge graph as new nodes or relationships. The integration of vector embeddings and knowledge graphs support efficient traversal, reasoning, and querying operations using both the discrete graph structure and the continuous vector space.

The integration of vector embeddings and knowledge graphs provides a unified approach to managing and querying complex datasets. The vector embeddings represent entities in a continuous space that captures semantic similarity, while the knowledge graph provides a discrete structure that captures explicit relationships. The embeddings enhance the graph by enabling similarity-based reasoning, while the graph enriches the embeddings with structured relational context. Together, the components allow for efficient knowledge representation and retrieval in applications requiring both structured and unstructured data.

In some embodiments, the generative AI model(s) may be called and/or enhanced through particularly engineered prompts. In some such embodiments, prompt engineering may involve the strategic formulation and structuring of prompts or queries to effectively interact with and guide LLMs towards generating desired outputs. Prompt engineering leverages the understanding of how LLMs interpret and process natural language inputs to craft prompts that can elicit specific types of responses or information. By carefully designing these prompts, users can enhance the relevance, accuracy, and utility of the responses generated by LLMs. Prompt engineering may therefore enable more efficient and targeted extraction of knowledge from vast datasets.

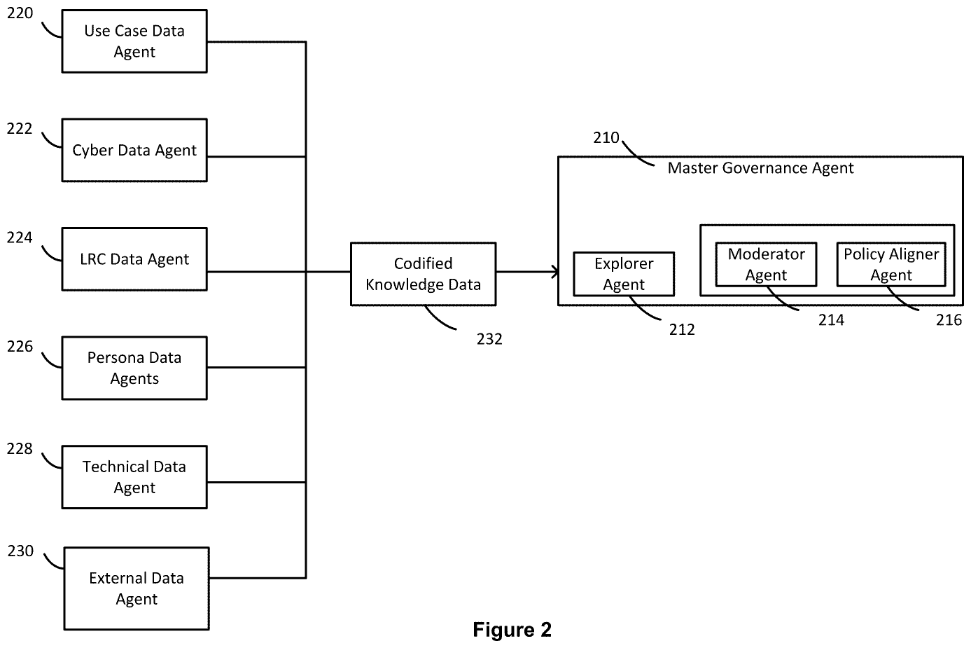

FIG. 2 depicts an exemplary system architecture for managing and governing data input and process flows within a computing environment, according to some embodiments. The architecture is structured such that multiple specialized data processing machine learning models 126 feed into a central master governance agent 210, with the data processing machine learning models 126 generating codified knowledge data. In some embodiments, a number of distinct data processing machine learning models 126 may be used, each with a dedicated role in data sourcing and processing. Depending on the embodiment, the models may include a use case data agent 220, cyber data agent 222, LRC data agent 224, persona data agents 226, technical data agent 228, and external data agent 230. Each of the agents may receive various data that are classified as knowledge data. The various data classified as knowledge data as a whole are considered composite knowledge data. The processed composite knowledge data is then synthesized to generate codified knowledge data.

The master governance agent 210 is represented on the right side of the figure. Within the master governance agent 210, there are three agent models: explorer agent 212, moderator agent 214, and policy aligner agent 216, each with a distinct function in the governance process.

In some embodiments, the master governance agent 210 receives the codified knowledge data 232, wherein the processed codified knowledge data 232 from the individual data processing machine learning models 126 is contextualized and synthesized within the master governance agent 210 through the collaborative functions of its internal components. For example, the master governance agent 210 may analyze the codified knowledge data via exploration by the explorer agent 212, moderation by the moderator agent 214, and/or policy alignment by the policy aligner agent 216, according to some embodiments.

In some embodiments, the explorer agent 212 aligns use cases with existing guardrails and identifies areas where current guardrails may need adjustment, either because the guardrails are too strict or too lenient. In some embodiments, the explorer agent 212 leverages large language models (LLMs), prompt engineering, and vector embeddings to process and reason about unstructured data from diverse sources, including text, tables, and diagrams. Such features may enable the explorer agent 212 to provide valuable insights into how generative AI can be effectively utilized within the organization while adhering to established guardrails.

In some embodiments, the moderator agent 214, which operates across all domains, focuses on content moderation and the handling of sensitive information, such as PII. The moderator agent 214 employs fine-tuning techniques, anomaly detection, and the distillation of knowledge from larger models to smaller, more specific models that are tailored to particular regulatory or use case requirements according to some embodiments. This ensures that the content generated by generative AI is appropriate and compliant with relevant standards, thereby mitigating the risks associated with AI-generated content.

In some embodiments, the policy aligner agent 216, tailored to individual personas or use cases, adjusts policies based on feedback and learning from data. The policy aligner agent 216 utilizes multi-agent reinforced learning for inter-agent interaction and federated learning to respect data privacy and compliance standards across different jurisdictions or organizational divisions according to some embodiments. The policy aligner agent 216 helps ensure that the framework remains adaptable and responsive to the evolving needs of the organization and the regulatory landscape.

In some embodiments, components of the master governance agent 210 can operate in concert. In some embodiments, components of the master governance agent 210 can operate independently. Components of the master governance agent 210 can be guided by the codified knowledge data, to bolster the governance framework and effectiveness to ensure a balanced, efficient, and compliant use of generative AI within an organization.

FIG. 2 thus presents a high-level architecture for a complex system designed to govern and manage various data inputs through specialized agents, then further process and align the data inputs within a master governance agent 210, ensuring that the computing system operates within set policies and guidelines, and is informed by the diverse data sources represented by the data processing machine learning models 126.

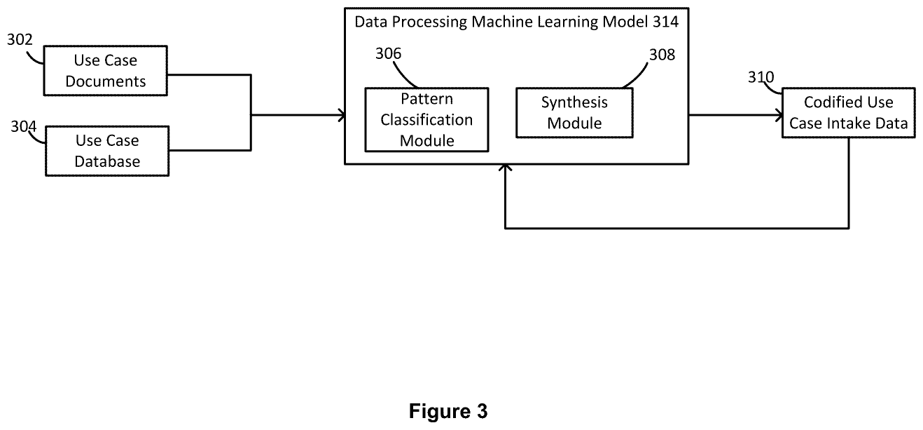

FIG. 3 depicts an exemplary data processing machine learning model 314 for processing use case documents and generating codified use case intake data, according to some embodiments. The high-level architecture illustrated in FIG. 3 may include both hardware and software components, as well as data communication mechanisms for exchanging data amongst the various modules, as is described below.

In some embodiments, the system may include a use case documents module 302, which may hold a collection of use case documents that provide detailed descriptions or narratives of various scenarios for which the data processing machine learning model 314 will be trained. The documents may encompass a variety of formats such as text documents, spreadsheets, or any other structured or unstructured data representation. Additionally, a use case database 304 may be received by the data processing machine learning model 314 according to some embodiments. The use case database 304 may serve as a repository for storing and cataloging use case documents that have been processed or are pending processing. The use case database 304 can be configured to allow for efficient querying and retrieval of use case data by the other components within the system.

In some embodiments, the architecture may also include a pattern classification module 306 which may operate to analyze the use case documents, identifying and categorizing patterns within the data. The pattern classification facilitates the understanding of consistent themes or cases that may exist within the use case documents.

In some embodiments, following the pattern classification, a synthesis module 308 may be employed to synthesize the classified patterns into a cohesive, structured format. The synthesis module 308 may leverage advanced algorithms to integrate and consolidate the data, aiming to translate the complex patterns into a standardized format that is more readily usable for further processing or analysis.

Finally, in some embodiments, the codified use case intake data 310 emerges as the output of the system. The codified use case intake data may represent the processed and synthesized information that has been converted into a standardized, structured format, ready for ingestion into the data processing machine learning model 314 or for use in other downstream applications or processes according to some embodiments. Further, the codified use case intake data can be received by the data processing machine learning model 314 for further synthesization according to some embodiments. The codified use case intake data is then received by the master governance agent 210 as part of the codified knowledge data. In some embodiments, the master governance agent 210 may then utilize the codified use case intake data 310 as part of the codified knowledge data to configure the agent models 124 to define appropriate behavior for a specific persona.

In summary, FIG. 3 demonstrates an architecture designed to systematically process use case documents into a refined, structured dataset, which may then be utilized to feed a data processing machine learning model 314, thereby facilitating the automated understanding and processing of complex scenario descriptions within an enterprise or application environment.

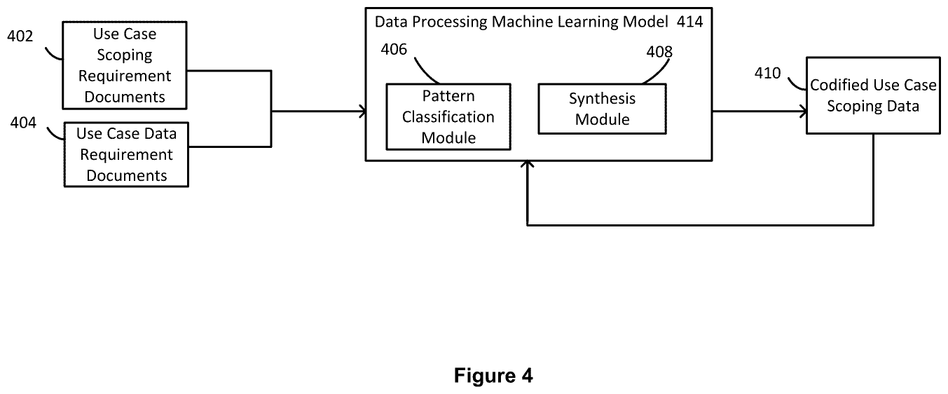

FIG. 4 depicts an exemplary data processing machine learning model 414, according to some embodiments. The high-level architecture illustrated in FIG. 4 may include both hardware and software applications, as well as various data communications channels for communicating data between the various hardware and software components, as is described below.

In some embodiments, the data processing machine learning model 414 may receive use case scoping requirement documents 402 and use case data requirement documents 404. The use case scoping requirement documents 402 and use case data requirement documents 404 may hold a collection of use case scoping requirement documents and use case data requirement documents that provide detailed descriptions or narratives of various scenarios for which the data processing machine learning model 414 will be trained according to some embodiments. The documents may encompass a variety of formats such as text documents, spreadsheets, or any other structured or unstructured data representation.

In some embodiments, the data processing machine learning model 414 may include a pattern classification module 406 and a synthesis module 408, configured to operate in a manner similar to that of the pattern classification module 306 and synthesis module 308. The codified use case scoping data 410 is then received by the master governance agent 210 as part of the codified knowledge data. The master governance agent 210 then utilizes the codified use case scoping data 410 as part of the codified knowledge data to configure the agent models 124 to determine details for specific use cases that define appropriate behavior for a specific persona according to some embodiments.

For example, codified use case scoping data can encompass a structured dataset derived from analyzing various HR-related documents that outline the scope and requirements for deploying AI technologies within an organization's HR department. This dataset may include parameters such as the scope of AI applications in HR tasks, specific HR functions to be automated, and compliance requirements related to employee data handling. The master governance agent 210 can then utilize this codified use case scoping data to define appropriate behavior for AI systems in HR scenarios. For instance, the master governance agent 210 may delineate the boundaries within which AI tools can be deployed for employee performance analysis while ensuring adherence to data privacy laws according to some embodiments. Additionally, the master governance agent 210 can configure AI systems to prioritize certain HR functions over others based on the scoping data, ensuring that the organization's strategic HR objectives are met through the use of generative AI.

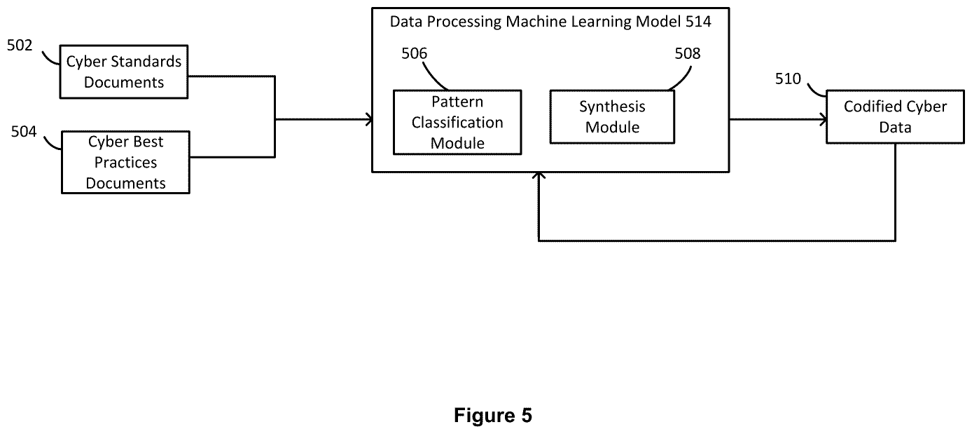

FIG. 5 depicts an exemplary system for processing cyber standards documents 502 and cyber best practices documents 504 into codified cyber data 510 using a data processing machine learning model 514, according to some embodiments. The system illustrated in FIG. 5 may encompass various software modules that interact with each other to convert and synthesize information from the documents into a structured format, which is then utilized within a computational context as described below.

In some embodiments, the data process machine learning model 514 may include a pattern classification module 506 and a synthesis module 508, configured to operate in a manner similar to that of the pattern classification module 306 and synthesis module 308. The output of the synthesization process is codified cyber data 510, which is then received by the master governance agent 210 as part of the codified knowledge data. The master governance agent 210 then utilizes codified cyber data 510 as part of the codified knowledge data to configure the agent models 124 to apply proper security policies to the output according to some embodiments.

For example, codified cyber data 510 can encompass a structured dataset derived from analyzing various cybersecurity documents and best practices that outline the cybersecurity measures and protocols for deploying AI technologies within an organization's HR department. This dataset may include parameters such as types of cybersecurity threats relevant to HR tasks, specific cybersecurity solutions to be implemented, and compliance requirements related to the protection of employee data against cyber threats according to some embodiments. The master governance agent 210 can then utilize the codified cyber data 510 to define appropriate cybersecurity behavior for AI systems in HR scenarios. For instance, the master governance agent 210 may recommend deploying certain cybersecurity tools for protecting employee data during recruitment processes while ensuring they adhere to the latest cybersecurity standards and practices according to some embodiments. Additionally, the master governance agent 210 can configure AI systems to automatically update their cybersecurity measures based on the evolving cyber threat landscape.

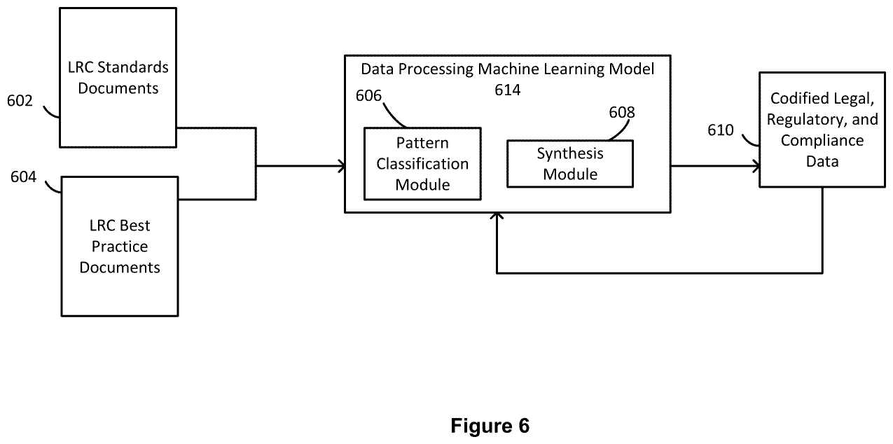

FIG. 6 depicts an exemplary data processing machine learning model 614 for managing and synthesizing legal, regulatory, and compliance (LRC) data, according to some embodiments. The detailed architecture illustrated in FIG. 6 may include various modules and data inputs that work collaboratively to process and output codified legal, regulatory, and compliance information, as is described below.

In some embodiments, the data processing machine learning model 614 may include input from LRC standards documents 602 and LRC best practice documents 604. These documents may provide the foundational LRC data on which the machine learning model operates.

In some embodiments, the data process machine learning model 614 may include a pattern classification module 606 and a synthesis module 608, configured to operate in a manner similar to that of the pattern classification module 306 and synthesis module 308. The codified LRC data 610 represents a structured and codified form of the received data, which is then received by the master governance agent 210 as part of the codified knowledge data according to some embodiments. The master governance agent 210 then utilizes codified LRC data 610 as part of the codified knowledge data to configure the agent models 124 to apply the appropriate legal, risk, and compliance standards.

For example, codified LRC data 610 can encompass a structured dataset derived from analyzing various HR-related legal documents, regulatory guidelines, and compliance standards that outline the legal, regulatory, and compliance framework within which AI technologies can be deployed in an organization's HR department according to some embodiments. In some embodiments, the structured dataset may include parameters such as legal restrictions on employee data usage, regulatory requirements for automated decision-making processes in HR, and compliance benchmarks for data protection and privacy. The master governance agent 210 can then utilize this codified LRC data to define appropriate behavior for AI systems in HR scenarios. For instance, the master governance agent 210 may ensure that AI tools used for employee performance evaluation are configured to comply with equal employment opportunity laws, or it may adjust AI-driven recruitment tools to adhere to data privacy regulations such as GDPR. Additionally, the master governance agent 210 can configure AI systems to automatically generate compliance reports.

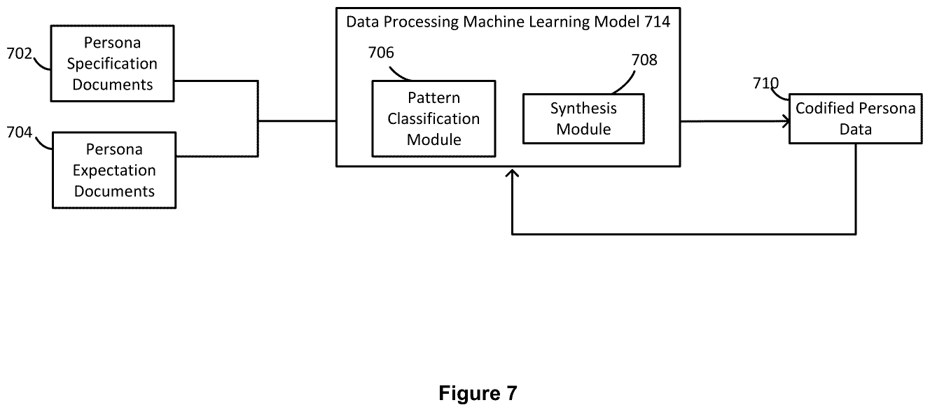

FIG. 7 depicts an exemplary data processing machine learning model 714 for the codification of persona data, according to some embodiments. The architecture illustrated in FIG. 7 may comprise software applications and modules, as well as data inputs and outputs for processing and codifying persona related information, as is described below.

In some embodiments, the data processing machine learning model 714 is designed to receive input from persona specification documents 702 and persona expectation documents 704. These documents contain data regarding the characteristics, behaviors, and expectations associated with a particular persona.

In some embodiments, the data process machine learning model 714 may include a pattern classification module 706 and a synthesis module 708, configured to operate in a manner similar to that of the pattern classification module 306 and synthesis module 308. The codified persona data 710 represents a structured and codified form of the received data, which is then received by the master governance agent 210 as part of the codified knowledge data according to some embodiments. The master governance agent 210 then utilizes the codified persona data 710 as part of the codified knowledge data to configure the agent models 124 to define personas based upon a use case family or specific use case. A use case family may include a business unit, such as HR, equity, real estate, etc. In some embodiments, a specific use case is a function of a business unit that may be for a persona outside of a certain business unit, but a user may be considered as part of another persona because their job functions extend to one or more functions related to a use case outside of their assigned use case family.

For example, codified persona data 710 can encompass a structured dataset derived from analyzing various HR-related documents that outline the scope and requirements for deploying AI technologies within an organization's HR department. The structured dataset may include parameters such as the scope of AI applications in HR tasks, specific HR functions to be automated, and compliance requirements related to employee data handling. The master governance agent can then utilize this codified persona data to define appropriate behavior for AI systems in HR scenarios. For instance, master governance agent 210 may delineate the boundaries within which AI tools can be deployed for employee performance analysis while ensuring adherence to data privacy laws. Additionally, the master governance agent 210 can configure AI systems to prioritize certain HR functions over others based on the scoping data.

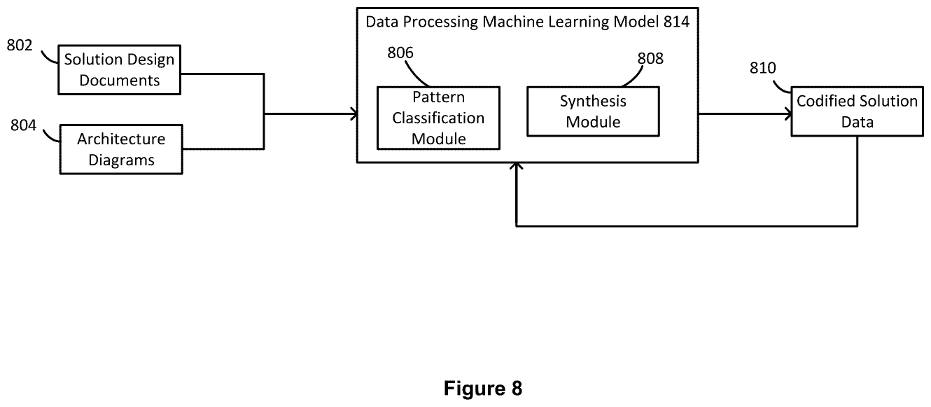

FIG. 8 depicts an exemplary data processing machine learning model 814, according to some embodiments. The data processing machine learning model 814 receives solution design documents 802 and architecture diagrams 804. Solution design documents 802 provide textual and other descriptive information of a solution, which along with the structural and conceptual information provided by architecture diagrams 804, are fed into the data processing machine learning model 814.

In some embodiments, the data process machine learning model 814 may include a pattern classification module 806 and a synthesis module 808, configured to operate in a manner similar to that of the pattern classification module 306 and synthesis module 308. The codified solution data 810 represents a structured and codified form of the received data, which is then received by the master governance agent 210 as part of the codified knowledge data according to some embodiments. The master governance agent 210 then utilizes the codified solution data 810 as part of the codified knowledge data to configure the agent models 124 to understand solution architecture and design information.

For example, codified solution data 810 can encompass a structured dataset derived from analyzing various HR-related solution design documents and architecture diagrams that outline the technical and operational framework for deploying AI technologies within an organization's HR department. The structured dataset may include parameters such as the technical specifications of AI tools for automating recruitment processes, the architectural design of data privacy safeguards, and compliance mechanisms related to employee data management according to some embodiments. The master governance agent 210 can then utilize this codified solution data to define appropriate behavior for AI systems in technology solution-oriented HR scenarios. For instance, the master governance agent 210 may ensure that AI tools for screening candidates are designed to eliminate bias and promote diversity, while also ensuring that the data architecture incorporates robust encryption and access control mechanisms to protect employee data. Additionally, the master governance agent 210 can configure AI systems to generate alerts for data leaks within the HR department.

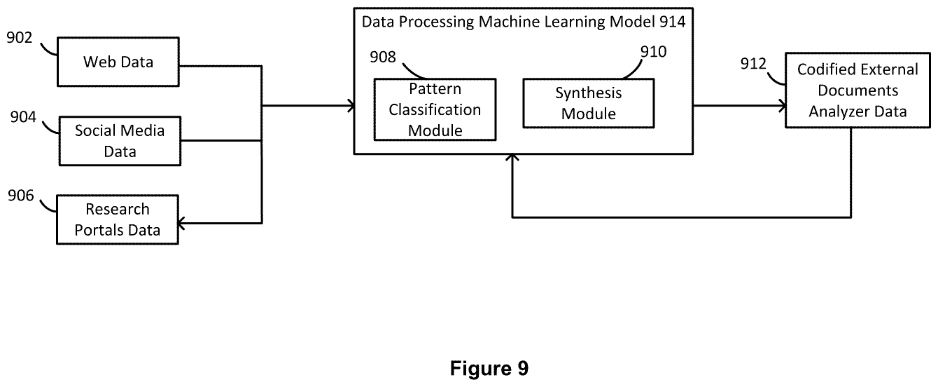

FIG. 9 depicts an exemplary data processing machine learning model 914 for the, according to some embodiments. The schematic architecture illustrated in FIG. 9 may include multiple data inputs and software modules managing the data processing workflow, as well as the interfaces between these modules, as is described below.

In some embodiments, the data processing machine learning model 914 may receive web data 902, social media data 904, and research portals data 906. These data sources may supply distinct types of information that can be in multiple formats, representative of different content types found across the internet and specialized data repositories.

In some embodiments, the data processing machine learning model 914 may include a pattern classification module 908 and a synthesis module 910, configured to operate in a manner similar to that of the pattern classification module 306 and synthesis module 308. The codified external documents analyzer data 912 represents a structured and codified form of the received data, which is then received by the master governance agent 210 as part of the codified knowledge data. The master governance agent 210 then utilizes the codified external documents analyzer data 912 as part of the codified knowledge data to configure the agent models 124 to understand industry trends including emerging national and regional standards and regulations.

For example, codified external documents analyzer data 912 can encompass a structured dataset derived from analyzing various external documents, such as industry reports, regulatory updates, and best practices guidelines, relevant to HR operations within an organization according to some embodiments. This dataset may include parameters such as emerging HR technologies, updates in labor laws, and best practices in employee engagement and retention. The master governance agent 210 can then utilize the codified external documents analyzer data 912 to define appropriate behavior for AI systems in HR scenarios. For instance, the master governance agent 210 may identify the need to update AI-driven recruitment tools to align with new diversity and inclusion standards. Additionally, the master governance agent 210 can configure AI systems to prioritize employee engagement initiatives based on new and emerging industry best practices, ensuring HR practices align with the latest trends and innovations in HR management.

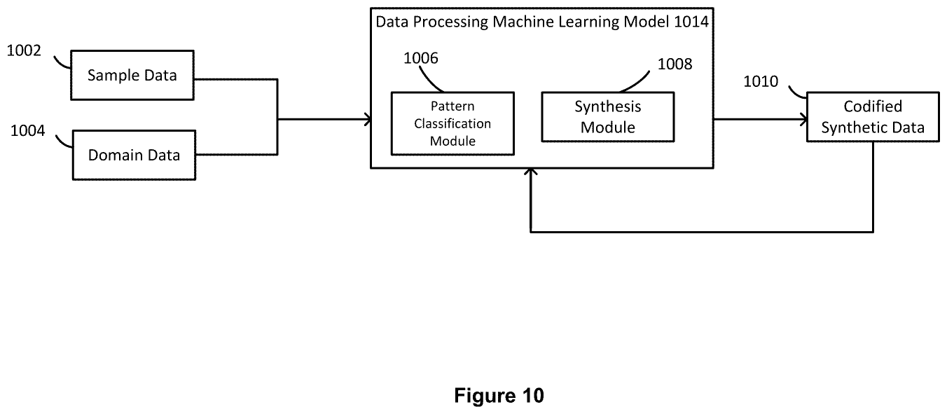

FIG. 10 depicts an exemplary data processing machine learning model 1014, according to some embodiments. The schematic architecture illustrated in FIG. 10 may include various modules and data inputs that work in concert to facilitate the generation of synthetic data, as is described below.

In some embodiments, the data processing machine learning model 1014 may receive sample data 1002 and domain data 1004. The data processing machine learning model 1014 may include a pattern classification module 1006 and a synthesis module 1008, configured to operate in a manner similar to that of the pattern classification module 306 and synthesis module 308. The codified synthetic data 1010 represents a structured and codified form of the received data, which is then received by the master governance agent 210 as part of the codified knowledge data. The master governance agent 210 then utilizes the codified synthetic data 1010 as part of the codified knowledge data to configure the agent models 124 to check system health using different testing scenarios.

For example, codified synthetic data 1010 can encompass a structured dataset derived from simulating various HR-related scenarios using synthetic generation techniques. This dataset may include parameters such as hypothetical employee performance metrics, simulated employee engagement surveys, and artificial case studies of HR interventions according to some embodiments. The master governance agent 210 can then utilize this codified synthetic data to define appropriate behavior for AI systems in HR scenarios. For instance, master governance agent 210 may use the codified synthetic data 1010 to model the impact of different HR policies on employee satisfaction and productivity, guiding the development of AI tools that support HR objectives. Additionally, the master governance agent 210 can configure AI systems to simulate the outcomes of various HR strategies, enabling the organization to evaluate the effectiveness of these strategies in a risk-free environment before implementation.

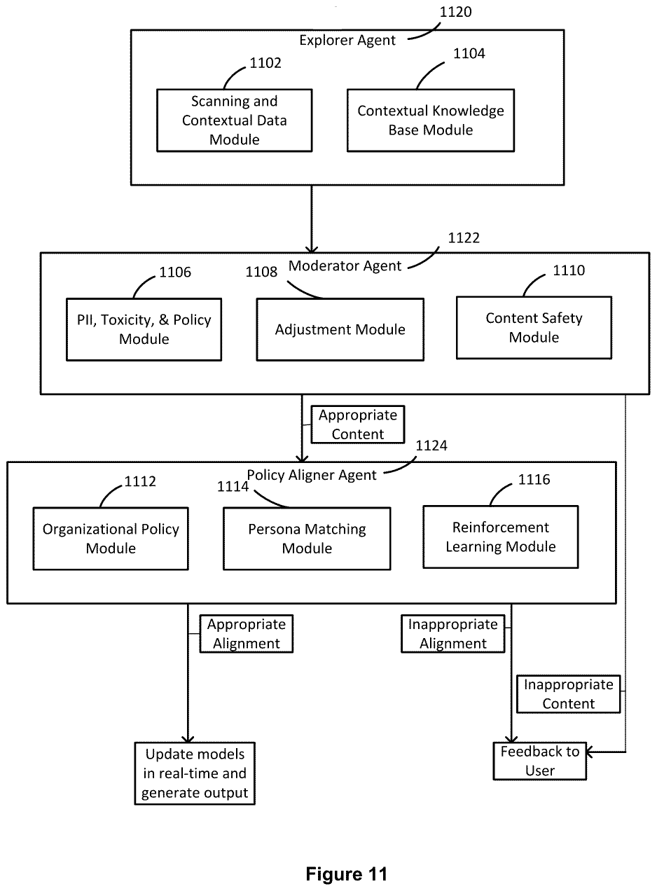

FIG. 11 illustrates an exemplary system for self-guided hyper-personalization governance, according to some embodiments. The detailed architecture depicted in FIG. 11 may encompass various modules and agents, each responsible for specific functions within the system, as is further elucidated below.

In some embodiments, the system depicted may include an explorer agent 1120 which consists of two subordinate modules: a scanning and contextual data module 1102 and a contextual knowledge base module 1104. The scanning and contextual data module 1102 is involved in the collection and initial processing of data, related to user interactions and environmental context. The contextual knowledge base module 1104 may function to store, retrieve, and manage the accumulated contextual data that the system uses to inform subsequent processes or decision-making. In some embodiments, the contextualized knowledge data generated by the explorer agent 1120 may then be received by the moderator agent 1122.

The moderator agent 1122 features three interconnected components: a PII, toxicity, & policy module 1106, an adjustment module 1108, and a content safety module 1110. The PII, toxicity, & policy module 1106 is tasked with assessing personal identifiable information PII, the presence of toxic content, and compliance with relevant policies. The adjustment module 1108 is responsible for reconciling discrepancies identified by the PII, toxicity, & policy module, thus ensuring appropriate content is presented. The content safety module 1110 serves a security function, maintaining the safety of the content before the content is processed further within the system. In some embodiments, the screened knowledge data generated by the moderator agent 1122 may then be received by the policy aligner agent 1124.

In some embodiments, the system further comprises a policy aligner agent 1124 which encompasses an organizational policy module 1112, a persona matching module 1114, and a reinforcement learning module 1116. The organizational policy module 1112 ensures that the output is in accordance with the organizational guidelines and policies. The persona matching module 1114 may be employed to align content with specific user personas, while the reinforcement learning module 1116 uses iterative feedback to refine the systems'algorithms and improve future performance based on outcomes and feedback. In some embodiments, the policy aligner agent 1124 generates aligned knowledge data to be processed in the generation of the output.

Although these agent models can work independently, if they work in tandem, the data generated by the explorer agent 1120 is received by the moderator agent 1122. The data generated by the moderator agent 1122 is received by the policy aligner if the moderator agent 1122 determines that the content received from the explorer agent 1120 is appropriate. The data generated by the moderator agent 1122 is received by the policy aligner agent 1124 if the policy aligner agent 1124 determines that the content is in appropriate alignment with organizational policies and persona operating parameters. If the content is not appropriate, or the content is not in appropriate alignment, feedback is given to the user. If the moderator agent 1122 and policy aligner agent 1124 determine the content to be appropriate content as well as appropriately aligned content, then the system updates the model in real time and generates an output in the form of a compliance action, or a recommendation related to a compliance action.

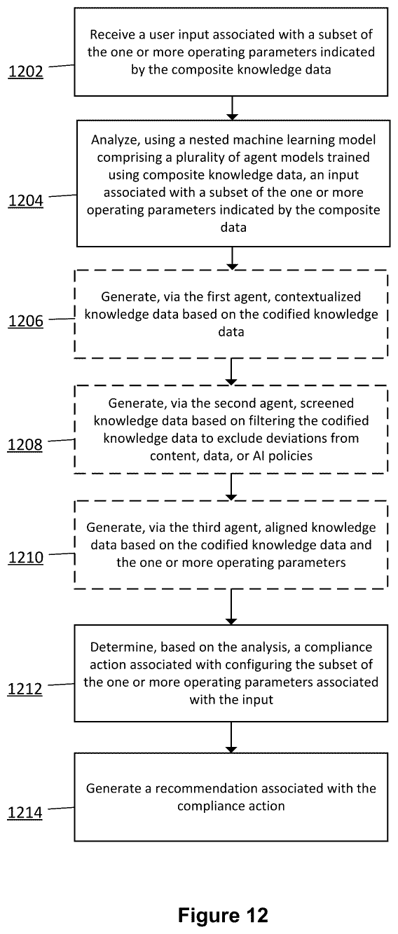

FIG. 12 presents an exemplary flow diagram for a method for self-guided hyper personalization governance. The method may be implemented by a computing environment 100, a component of the computing environment 100, a computing device communicating with the computing environment 100, and/or any other such device as described herein. It will be understood that additional, fewer, and/or alternate components may be used to implement the example method, and/or that the method may include more or fewer blocks than shown (and/or in a different order than shown).

In some embodiments, at block 1202, a computing device receives user input associated with a subset of the one or more operating parameters as highlighted by the composite knowledge data. In further implementations, the operating parameters may be associated with one or more compliance guidelines and/or guardrails (e.g., password requirements, privacy requirements, access credentials, etc.).

In some embodiments, at block 1204 and responsive to the initial receipt of knowledge data, the computing device analyzes the knowledge data. In some embodiments, the computing device analyzes the knowledge data using a nested machine learning model (e.g., nested machine learning model 134). The nested machine learning model 134 may include a plurality of agent models (e.g., agent models 124) trained using composite knowledge data, as described above with regard to FIG. 1. The composite knowledge data is derived from the initial knowledge data through the application of one or more data processing machine learning models 126. In further implementation, at block 1204, the computing device analyzes input that is directly associated with a subset of the operating parameters as indicated by the composite knowledge data. In some embodiments, the composite knowledge data is codified knowledge data generated via the one or more data processing machine learning models 126 by synthesizing the composite knowledge data.

In some embodiments, at block 1206, the computing device optionally details the generation of contextualized knowledge data via a first agent, utilizing the codified knowledge data. In some such implementations, the computing device enhances the initial input by adding layers of context and relevance, offering further improvements in accuracy and speed of analysis through the additional context and/or relevance.

In some embodiments, at block 1208, the computing device optionally generates screened knowledge data by the second agent. In further such embodiments, the computing device may filter the codified knowledge data to remove any deviations from established content, data, or AI policies, ensuring compliance and relevance of the output recommendation(s).

In some embodiments, at block 1210, the computing device optionally generates aligned knowledge data through a third agent. In further such embodiments, the computing device may align the received knowledge data with the one or more operating parameters and the user input, ensuring the output is correctly aligned with a specified access level for the user.

In some embodiments, at block 1212, the computing device determines a compliance action based on the analysis conducted by the nested machine learning model 134. In further such embodiments, the computing device translates the insights derived from the analysis into actionable measures. For example, the compliance action may be associated with configuring the subset of the one or more operating parameters that are related to the received input. In still further embodiments, the computing device ensures that the governance framework is adaptive to the specific requirements and contexts indicated by the input. In particular, by determining a compliance action that is closely aligned with the analyzed data, the computing device tailors one or more governance mechanisms to meet the needs of the operational environment. In some embodiments, the subset of operating parameters are operating parameters associated with one or more personas, and the one or more personas may include at least one of: (i) a marketing persona, (ii) an HR persona, (iii) a learning team persona, (iv) a business persona, and/or any other such persona or combination thereof. In some embodiments, the compliance action includes a configuration to a user access credentials to a user system 120.

In some embodiments, at block 1214, the computing device generates a recommendation associated with a compliance action. In some such embodiments, the computing device compiles the insights from the preceding steps into a coherent recommendation or action, specifically tailored to meet a personalized access level of a persona (e.g., the persona associated with the user) and requirements while adhering to the governance protocols for the overarching system.

### Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
Aspect 1. A computer-implemented method for managing governance operating parameters using machine learning, the method comprising: receiving, by one or more processors, knowledge data, wherein the knowledge data is indicative of one or more operating parameters; analyzing, by the one or more processors using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data; determining, by the one or more processors based on the analyzing, a compliance action, wherein the compliance action is associated with configuring the subset of the one or more operating parameters associated with the input; and generating, by the one or more processors using the nested machine learning model, a recommendation associated with the compliance action.
Aspect 2. The method of aspect 1, wherein the nested machine learning model is a master governance agent, wherein the plurality of agent models comprising the master governance agent comprise of: i) a first agent, ii) a second agent, and iii) one or more third agents.
Aspect 3. The method of any of aspects 1-2, further comprising: generating, via the one or more data processing machine learning models, codified knowledge data by synthesizing the composite knowledge data.
Aspect 4. The method of any of aspects 1-3, further comprising: in response to receiving the codified knowledge data, generating via the first agent, contextualized knowledge data based on the codified knowledge data.
Aspect 5. The method of any of aspects 1-3, further comprising: in response to receiving the codified knowledge data, generating via the second agent, screened knowledge data based on filtering the codified knowledge data to exclude deviations from content, data, or AI policies.
Aspect 6. The method of any of aspects 1-3, further comprising: In response to receiving the codified knowledge data, generating via the third agent, aligned knowledge data based on the codified knowledge data and the one or more operating parameters.
Aspect 7. The method of any of aspects 1-3, wherein the subset of operating parameters are operating parameters associated with one or more personas, wherein the one or more personas includes at least one of: i) a marketing persona, ii) an HR persona, iii) a learning team persona, or iv) a business persona.
Aspect 8. The method of any of aspects 1-3, wherein the compliance action includes a configuration to a user access credentials to a user system.
Aspect 9. A computing system for managing governance using machine learning, the system comprising: One or more processors; and One or more non-transitory memories, the one or more non-transitory memories having stored thereon computer-executable instructions that, when executed by the one or more processors, cause the one or more processors to: receive knowledge data, wherein the knowledge data is indicative of one or more operating parameters; analyze, using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data; determine based on the analyzing, a compliance action, wherein the compliance action is associated with configuring the subset of the one or more operating parameters associated with the input; and generate using the nested machine learning model, a recommendation associated with the compliance action.
Aspect 10. The computing system of aspect 9, wherein the nested machine learning model is a master governance agent, wherein the plurality of agent models comprising the master governance agent comprise of: i) a first agent, ii) a second agent, and iii) one or more third agents.
Aspect 11. The computing system of any of aspects 9-10, further comprising: the one or more non-transitory memories of the computer system having stored thereon computer executable instructions that, when executed by the one or more processors, cause the one or more data processing machine learning models to generate codified knowledge data by synthesizing the composite knowledge data.
Aspect 12. The computing system of any of aspects 9-11, further comprising: the one or more non-transitory memories having stored thereon computer executable instructions that, when executed by the one or more processors, cause the first agent to generate contextualized knowledge data based on the codified knowledge data.
Aspect 13. The computing system of any of aspects 9-11, further comprising: the one or more non-transitory memories having stored thereon computer executable instructions that, when executed by the one or more processors, cause the second agent to generate screened knowledge data based on filtering the codified knowledge data to exclude deviations from content, data, or AI policies.
Aspect 14. The computing system of any of aspects 9-11, further comprising: the one or more non-transitory memories having stored thereon computer executable instructions that, when executed by the one or more processors, cause the one or more third agents generate aligned knowledge data based on the codified knowledge data and the one or more operating parameters.
Aspect 15. The computing system of any of aspects 9-11, wherein the subset of operating parameters are operating parameters associated with one or more personas, wherein the one or more personas includes at least one of: i) a marketing persona, ii) an HR persona, iii) a learning team persona, or iv) a business persona.
Aspect 16. The computing system of any of aspects 9-11, wherein: the compliance action includes a configuration to a user access credentials to a user system.
Aspect 17. A computer-readable medium including instructions that, when executed on a processor, cause the processor to perform operations for managing governance using machine learning, the operations comprising: Receiving knowledge data wherein the knowledge data is indicative of one or more operating parameters; analyzing, using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data; determining, based on the analyzing, a compliance action, wherein the compliance action is associated with configuring the subset of the one or more operating parameters associated with the input; and generating, using the nested machine learning model, a recommendation associated with the compliance action.
Aspect 18. The computer-readable medium of aspect 17, wherein the nested machine learning model is a master governance agent, wherein the plurality of agent models comprising the master governance agent comprise of: i) a first agent, ii) a second agent, and iii) one or more third agents.
Aspect 19. The computer-readable medium of any of aspects 17-18, further comprising: Generating, via the one or more data processing machine learning models, codified knowledge data by synthesizing the composite knowledge data.
Aspect 20. The computer-readable medium of any of aspects 17-19, further comprising: In response to receiving the codified knowledge data, generating via the first agent, contextualized knowledge data based on the codified knowledge data.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent other than the language of the claims. To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112f.

Unless specifically stated otherwise, discussions herein using words such as “processing,” “computing,” “calculating,” “determining,” “presenting,” “displaying,” or the like may refer to actions or processes of a machine e.g., a computer that manipulates or transforms data represented as physical e.g., electronic, magnetic, or optical quantities within one or more memories e.g., volatile memory, non-volatile memory, or a combination thereof, registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true or present and B is false or not present, A is false or not present and B is true or present, and both A and B are true or present.

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for managing governance operating parameters using machine learning, the method comprising:
receiving, by one or more processors, knowledge data, wherein the knowledge data is indicative of one or more operating parameters;
analyzing, by the one or more processors using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data;
determining, by the one or more processors based on the analyzing, a compliance action, wherein the compliance action is associated with configuring the subset of the one or more operating parameters associated with the input; and
generating, by the one or more processors using the nested machine learning model, a recommendation associated with the compliance action.

2. The method of claim 1, wherein the nested machine learning model is a master governance agent, wherein the plurality of agent models comprising the master governance agent comprise of: (i) a first agent, (ii) a second agent, and (iii) one or more third agents.

3. The method of claim 2, further comprising:
generating, via the one or more data processing machine learning models, codified knowledge data by synthesizing the composite knowledge data.

4. The method of claim 3, further comprising:
in response to receiving the codified knowledge data, generating via the first agent, contextualized knowledge data based on the codified knowledge data.

5. The method of claim 3, further comprising:
in response to receiving the codified knowledge data, generating via the second agent, screened knowledge data based on filtering the codified knowledge data to exclude deviations from content, data, or AI policies.

6. The method of claim 3, further comprising:
in response to receiving the codified knowledge data, generating via the third agent, aligned knowledge data based on the codified knowledge data and the one or more operating parameters.

7. The method of claim 3, wherein the subset of operating parameters are operating parameters associated with one or more personas, wherein the one or more personas includes at least one of:
(i) a marketing persona,
(ii) an HR persona,
(iii) a learning team persona, or
(iv) a business persona.

8. The method of claim 3, wherein the compliance action includes a configuration to a user access credentials to a user system.

9. A computing system for managing governance using machine learning, the system comprising:
one or more processors; and
one or more non-transitory memories, the one or more non-transitory memories having stored thereon computer-executable instructions that, when executed by the one or more processors, cause the one or more processors to:
receive knowledge data, wherein the knowledge data is indicative of one or more operating parameters;
analyze, using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data;
determine based on the analyzing, a compliance action, wherein the compliance action is associated with configuring the subset of the one or more operating parameters associated with the input; and
generate using the nested machine learning model, a recommendation associated with the compliance action.

10. The computing system of claim 9, wherein the nested machine learning model is a master governance agent, wherein the plurality of agent models comprising the master governance agent comprise of: (i) a first agent, (ii) a second agent, and (iii) one or more third agents.

11. The computing system of claim 10, further comprising:
the one or more non-transitory memories of the computer system having stored thereon computer executable instructions that, when executed by the one or more processors, cause the one or more data processing machine learning models to generate codified knowledge data by synthesizing the composite knowledge data.

12. The computing system of claim 11, further comprising:
the one or more non-transitory memories having stored thereon computer executable instructions that, when executed by the one or more processors, cause the first agent to generate contextualized knowledge data based on the codified knowledge data.

13. The computing system of claim 11, further comprising:
the one or more non-transitory memories having stored thereon computer executable instructions that, when executed by the one or more processors, cause the second agent to generate screened knowledge data based on filtering the codified knowledge data to exclude deviations from content, data, or AI policies.

14. The computing system of claim 11, further comprising:
the one or more non-transitory memories having stored thereon computer executable instructions that, when executed by the one or more processors, cause the one or more third agents generate aligned knowledge data based on the codified knowledge data and the one or more operating parameters.

15. The computing system of claim 11, wherein the subset of operating parameters are operating parameters associated with one or more personas, wherein the one or more personas includes at least one of:
(i) a marketing persona,
(ii) an HR persona,
(iii) a learning team persona, or
(iv) a business persona.

16. The computing system of claim 11, wherein:
the compliance action includes a configuration to a user access credentials to a user system.

17. A computer-readable medium including instructions that, when executed on a processor, cause the processor to perform operations for managing governance using machine learning, the operations comprising:
receiving knowledge data wherein the knowledge data is indicative of one or more operating parameters;
analyzing, using a nested machine learning model comprising a plurality of agent models trained using composite knowledge data, an input associated with a subset of the one or more operating parameters indicated by the composite knowledge data, wherein the composite knowledge data is generated by one or more data processing machine learning models based on the knowledge data;
determining, based on the analyzing, a compliance action, wherein the compliance action is associated with configuring the subset of the one or more operating parameters associated with the input; and
generating, using the nested machine learning model, a recommendation associated with the compliance action.

18. The computer-readable medium of claim 17, wherein the nested machine learning model is a master governance agent, wherein the plurality of agent models comprising the master governance agent comprise of: (i) a first agent, (ii) a second agent, and (iii) one or more third agents.

19. The computer-readable medium of claim 18, further comprising:
generating, via the one or more data processing machine learning models, codified knowledge data by synthesizing the composite knowledge data.

20. The computer-readable medium of claim 19, further comprising:
in response to receiving the codified knowledge data, generating via the first agent, contextualized knowledge data based on the codified knowledge data.
